(19) United States
(12) Patent Application Publication
(10) Pub. No.: US 2019/0061118 A1
(43) Pub. Date: Feb. 28, 2019

(54) PIPE WRENCHES WITH HOUSINGS HAVING EXPANDED OPENINGS OR SHIMS

(71) Applicant: Ridge Tool Company, Elyria, OH (US)

(72) Inventors: Craig J. Nitchman, Wakeman, OH (US); Glen R. Chartier, Avon Lake, OH (US); James E. Hamm, Grafton, OH (US); Ashok Bhagwat Patil, Pune (IN); Rahul Maruti Nanche, Maharashtra (IN); Hiten Mansukh Chauhan, Pune (IN)

(21) Appl. No.: 15/832,138

(22) Filed: Dec. 5, 2017

(30) Foreign Application Priority Data
Aug. 31, 2017 (IN) IN 201741030854

(51) Int. Cl. B25B 23/00; B25B 13/50; B25B 13/12

(52) U.S. Cl. CPC B25B 23/0007; B25B 13/12; B25B 13/5008

(57) ABSTRACT

Wrenches such as pipe wrenches or Stillson wrenches are described that include particular geometries for a channel extending through the wrench housing. Also described are wrenches such as pipe wrenches or Stillson wrenches that include one or more shim components positioned in the channel. Furthermore, methods to reduce failure or fracturing of the wrench due to application of high side or lateral loads are described.

### FIELD

The present subject matter relates to wrenches and particularly Stillson wrenches having expanded or curved openings in a housing of the wrench. The present subject matter also relates to the use of one or more shims in wrench housings, and particularly in Stillson wrenches. The present subject matter also relates to methods for reducing potential for failure due to excessive lateral loading of wrenches.

### BACKGROUND

Stillson wrenches (commonly known as “pipe wrenches”) or other such wrenches utilize a heel jaw (referred to herein as a lower jaw) secured to a handle and a movable hook jaw (referred to herein as an upper jaw) which also pivots to a limited extent about the handle. Typically, the hook jaw can be selectively positioned relative to the heel jaw by rotating a threaded member on the wrench. The pivoting action of the hook jaw causes the hook jaw and heel jaw to further close as a rotational force is applied to the handle. Thus, gripping force and torque are simultaneously applied to a workpiece.

In order to increase loads or force applied to the wrench, users often place a pipe or other long member over the wrench handle to effectively lengthen the handle. During application of force to the lengthened handle, such as during gripping of a workpiece, lateral displacement of the handle may occur relative to the plane in which force is being applied. Such lateral displacement applies significant loads or forces to the wrench housing, which may result in damage to the wrench. As a result, fracture of the wrench body may occur and typically along side regions of the housing.

Accordingly, an improved wrench or wrench housing is desired which exhibits increased capacity to side or lateral loading, and particularly increased capacity for loads associated with lateral displacement of the handle during gripping of a workpiece. Furthermore, it would also be desirable to provide an improved wrench or wrench housing that was capable of handling side or lateral loading to a greater extent as compared to conventional wrenches, without damage or fracture of the wrench body.

### SUMMARY

The difficulties and drawbacks associated with previous approaches are addressed in the present subject matter as follows.

In one aspect, the present subject matter provides a wrench comprising a handle having a distal end and a proximate end. The wrench also comprises a movable upper jaw having a shank. The shank includes a threaded region. The wrench also comprises a housing integrally formed with the proximate end of the handle. The housing includes a lower jaw portion and a channel sized to receive the shank of the movable upper jaw. The shank of the upper jaw is disposed in the channel. The wrench also comprises a rotatable member threadedly engaged with the threaded region of the shank of the upper jaw. The member is rotatably secured to at least one of the handle and the housing. Upon rotation of the member, the distance between the lower jaw and the upper jaw is selectively adjusted. The channel extends between a first opening on a first face of the housing and a second opening on a second face of the housing. The first face is directed toward the upper jaw and the second face is directed toward the distal end of the handle. The area of the first opening is greater than the area of the second opening.

In another aspect, the present subject matter provides a wrench comprising a handle and a housing affixed to the handle. The housing defines a first face and a second face oppositely directed from the first face. The housing includes a lower jaw proximate the first face. The housing defines a plurality of interior walls defining a channel that extends through the housing between the first face and the second face. The wrench also comprises a movable upper jaw having a shank. The shank includes a threaded region. At least a portion of the shank is disposed in the channel in the housing. The wrench also comprise a rotatable member threadedly engaged with the threaded region of the shank of the upper jaw. The member is rotatably secured to at least one of the handle and the housing. Upon rotation of the member, the distance between the lower jaw and the upper jaw is selectively adjusted. At least one of the interior walls extending through the housing includes an arcuate region.

In yet another aspect, the present subject matter provides a wrench comprising a movable upper jaw having a shank. The shank includes a threaded region. The wrench also comprises a handle having a distal end and a proximate end. The wrench additionally comprises a housing integrally formed with the proximate end of the handle. The housing includes a lower jaw portion and a channel sized to receive the shank of the movable upper jaw. The shank of the upper jaw is disposed in the channel. The channel is defined by a plurality of interior walls extending through the housing. The wrench also comprises a rotatable member threadedly engaged with the threaded region of the shank of the upper jaw. The member is rotatably secured to at least one of the handle and the housing. Upon rotation of the member, the distance between the lower jaw and the upper jaw is selectively adjusted. The wrench also comprises a shim disposed in the channel and at least a portion of the shim positioned between the shank and at least three interior walls of the plurality of interior walls defining the channel.

In still another aspect, the present subject matter provides a method of increasing capacity of a wrench to lateral loading. The method comprises providing a wrench including a handle, a housing having a lower jaw and a channel defined by a plurality of interior walls extending through the housing, a movable upper jaw having a threaded shank and the shank disposed in the channel, a rotatable member threadedly engaged with the threaded shank such that upon rotation of the member the distance between the lower jaw and the upper jaw is selectively adjusted. The method also comprises incorporating at least one feature in the housing of the wrench, in which the feature is selected from (i) wherein at least one of the interior walls of the plurality of interior walls that define the channel, includes an arcuate portion, (ii) wherein the channel extends between a first opening and a second opening defined on the housing, and the area of the first opening is greater than the area of the second opening, (iii) wherein the plurality of interior walls that define the channel include a pair of diverging interior walls, and (iv) a shim disposed in the channel and positioned between at least three of the interior walls of the plurality of interior walls and the shank.

As will be realized, the subject matter described herein is capable of other and different embodiments and its several details are capable of modifications in various respects, all without departing from the claimed subject matter. Accordingly, the drawings and description are to be regarded as illustrative and not restrictive.

### BRIEF DESCRIPTION OF THE DRAWINGS

FIG. 1 is an illustration of an embodiment of a Stillson wrench in accordance with the present subject matter applied to a pipe.

FIG. 2 is a top view of the wrench and pipe depicted in FIG. 1.

FIG. 3 is a cross section of a conventional wrench during application of lateral loading.

FIG. 4 is a cross section of an embodiment of a wrench in accordance with the present subject matter during application of lateral loading.

FIG. 5 is a cross section of the wrench housing depicted in FIG. 4 in accordance with the present subject matter.

FIG. 6 is a cross section of the wrench housing depicted in FIG. 5 and a shim positioned in a channel in the housing in accordance with the present subject matter.

FIG. 7 is a schematic view of the shim of FIG. 6 in accordance with the present subject matter.

FIG. 8 is a cross section of a wrench having a housing in accordance with the present subject matter and a conventional shim component.

FIG. 9 is a cross section of another embodiment of a wrench housing in accordance with the present subject matter.

FIG. 10 is an end view of a conventional wrench housing with a shim of the present subject matter positioned in a channel of the housing.

FIG. 11 is a detailed end view of the conventional wrench housing with an embodiment of a shim component in accordance with the present subject matter, depicted in FIG. 10.

### DETAILED DESCRIPTION OF THE EMBODIMENTS

The present subject matter provides wrenches and particularly Stillson wrenches (typically referred to as pipe wrenches), which exhibit increased capacity to withstand damage to the wrench housing upon application of laterally directed loading. The increased resistance to damage of the wrench housing results from one or both of the following features.

One feature is the incorporation of one or more geometrical features of a channel extending through the wrench housing within which the shank of the upper jaw is disposed. The particular channel geometry can include one or more of (i) interior walls that diverge apart from one another, (ii) interior wall(s) having one or more regions or portions that are arcuate or non-linear, and/or (iii) openings at opposing faces on the wrench housing having different sizes.

Another feature is the provision of a particular shim component that is disposed in the channel of the wrench housing. The shim is positioned at least partially around the shank of the upper jaw and positioned between the shank and at least three of the interior walls that define the channel extending through the wrench housing.

One or both of these features or variations thereof, may be incorporated in a wrench. Incorporating such features into wrenches has been found to surprisingly and unexpectedly result in significant increases in load capacity of the wrench and ability to withstand damage resulting from lateral loading.

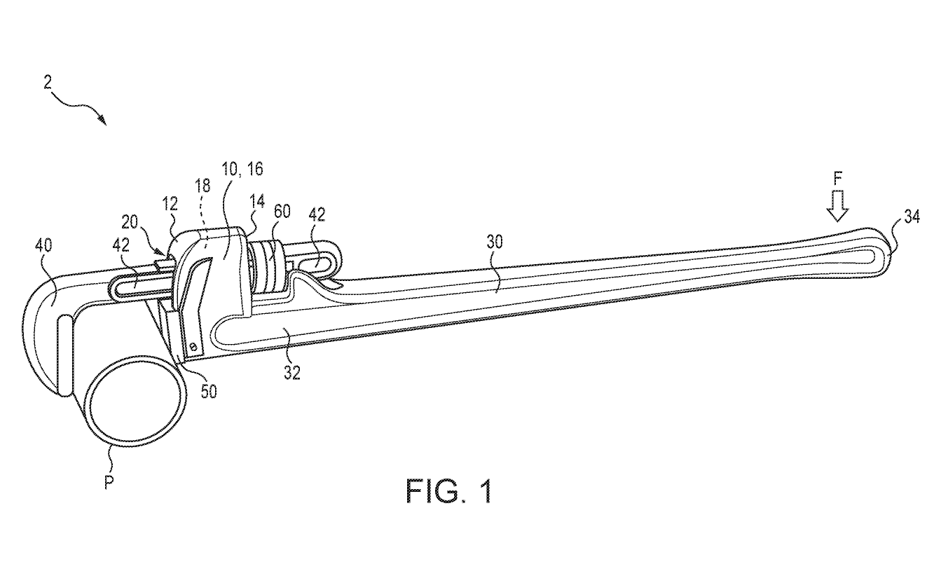

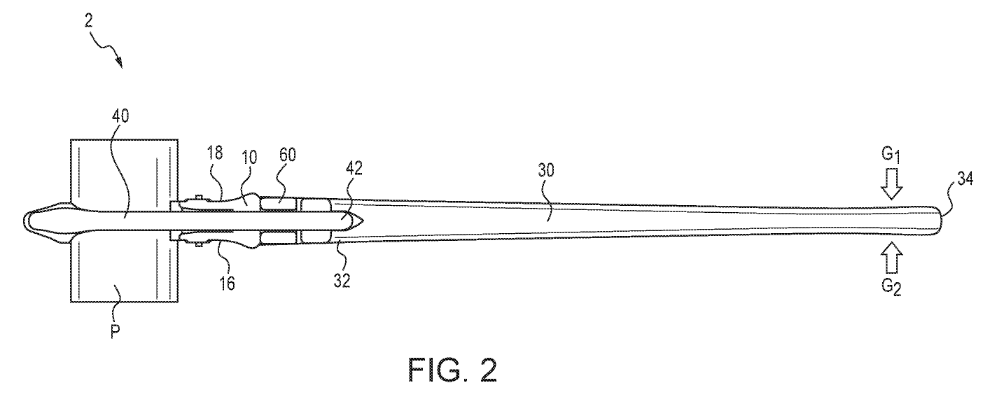

FIGS. 1 and 2 illustrate an embodiment of a wrench 2 in accordance with the present subject matter. The wrench 2 generally comprises a housing 10, a handle 30, a movable upper jaw 40, a lower jaw 50, and a rotatable member 60 for adjusting the distance between the upper jaw 40 and the lower jaw 50. The wrench 2 is shown gripping a workpiece or pipe P. The handle 30 has a proximate end 32 and an opposite distal end 34. The movable upper jaw 40 includes a shank 42 having a threaded region. The housing 10 is typically integrally formed with the proximate end 32 of the handle 30. The housing 10 defines a first face 12, an oppositely directed second face 14, a first lateral side 16, and an oppositely directed second lateral side 18. The first face 12 is generally directed toward a work region of the wrench, and the second face 14 is generally directed toward the distal end 34 of the handle 30. The housing 10 defines a channel 20 extending through the housing 10 between the first face 12 and the second face 14. The channel 20 is sized to receive the shank 42 of the upper jaw 40. The rotatable member 60 is threadedly engaged with the threaded region of the shank 42 of the upper jaw 40. The member 60 is rotatably secured to one or both of the handle 30 and/or the housing 10. It will be understood, that upon rotation of the member 60, the distance between the jaws 40 and 50 is selectively adjusted.

FIG. 1 further depicts a typical force F applied to the handle 30 of the wrench 2 during gripping of the workpiece P. As will be understood, the pivoting action of the upper jaw 40 causes the upper jaw 40 and the lower jaw 50 to further close as the force F is applied to the handle 30.

FIG. 2 further depicts typical lateral forces G₁ and G₂, either of which may be applied to the handle 30 or wrench 2. Application of such lateral forces G₁ and/or G₂ can result in damage to a conventional wrench. Such lateral forces G₁ and/or G₂ may be applied intentionally or unintentionally by a user. In certain applications such forces may be applied by a user when attempting to apply a large force F (see FIG. 1).

FIG. 3 is a cross sectional view of a conventional wrench 2A during application of a lateral force G₁. For convenience, reference numbers of conventional wrench components corresponding to components of embodiments of the present subject matter are denoted with a suffix “A.” For example, a housing in a conventional wrench 2A is denoted as housing 10A. Referring further to FIG. 3, upon application of the lateral force G₁ to the handle 30A and housing 10A, the upper jaw 40A and its shank 42A are laterally displaced in the channel 20A extending through the housing 10A. As a result of such lateral displacement, a region of contact x occurs between the shank 42A and an interior wall of the channel 20A. The region of contact x is relatively small in surface area and so the resulting loading at that region is relatively high. If the lateral force G₁ is sufficiently large, damage such as material fracture can occur at or around the region of contact x.

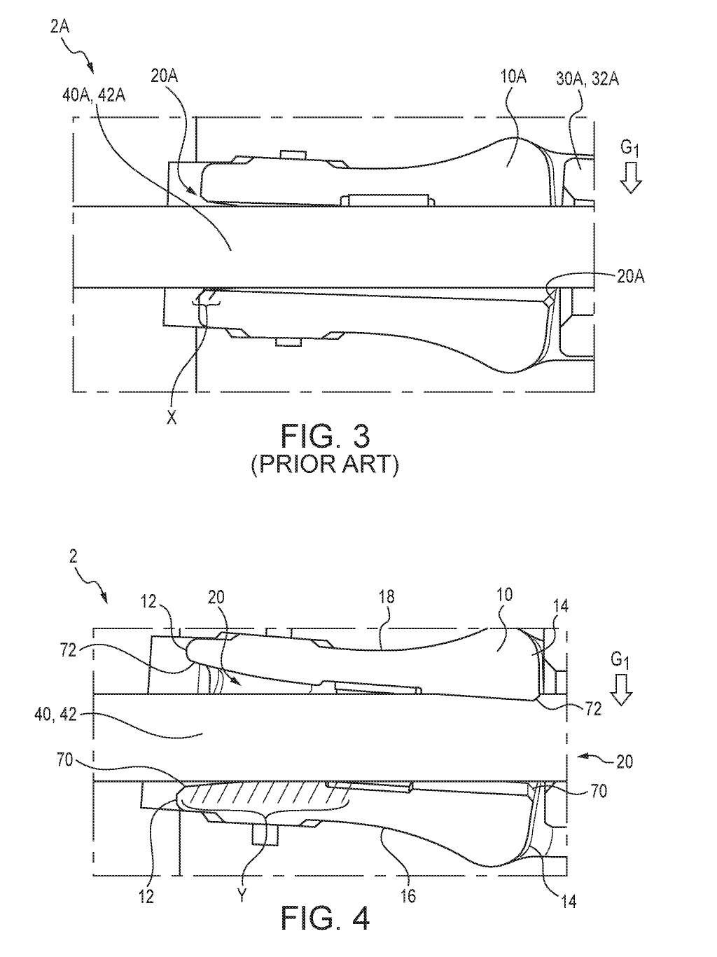

FIG. 4 is a cross section of an embodiment of the wrench 2 in accordance with the present subject matter. In this embodiment, the channel 20 extending through the housing 10 between faces 12 and 14 includes one or more interior walls that include an arcuate region or portion. For example, the channel 20 is defined at least in part by interior walls 70 and 72 extending between the faces 12 and 14 of the housing 10. The interior wall 70 includes an arcuate region 71 adjacent the face 12 and extending along at least a portion of the interior wall 70. As a result, a region of contact y exists between the shank 42 and the interior wall 70 of the channel 20. The region of contact y is significantly greater than the region of contact x of a conventional wrench shown in FIG. 3. Thus, the resulting loading occurring at region y is much less than that occurring at region x for the same lateral force G₁. Therefore, the potential for damage to the wrench 2 or its components is significantly reduced. FIG. 4 also illustrates an arcuate region 73 extending along at least a portion of the interior wall 72.

In many embodiments, when an arcuate region or portion of an interior wall is provided, the surface area of the arcuate region constitutes at least 10%, in certain embodiments at least 25%, and in particular embodiments at least 50% of the surface area of the interior wall extending between opposite faces of the housing. Thus, referring to FIG. 4 for example, the surface area of the arcuate region 71 constitutes at least 10%, in certain embodiments at least 25%, and in particular embodiments at least 50% of the surface area of the interior wall 70 extending between faces 12 and 14 of the housing 10.

The present subject matter includes a variety of geometries and/or configurations for the channel extending through the housing. For example the channel can include a pair of diverging interior walls that extend through at least a portion of the housing. The channel can include interior walls that include multiple arcuate regions or arcuate portions. The channel can include two interior walls that have arcuate portions opposite one another. The channel can include one or more interior walls with arcuate portions in which each arcuate portion is located proximate to or adjacent to a side region of the housing, and/or proximate to or adjacent a first face of the housing.

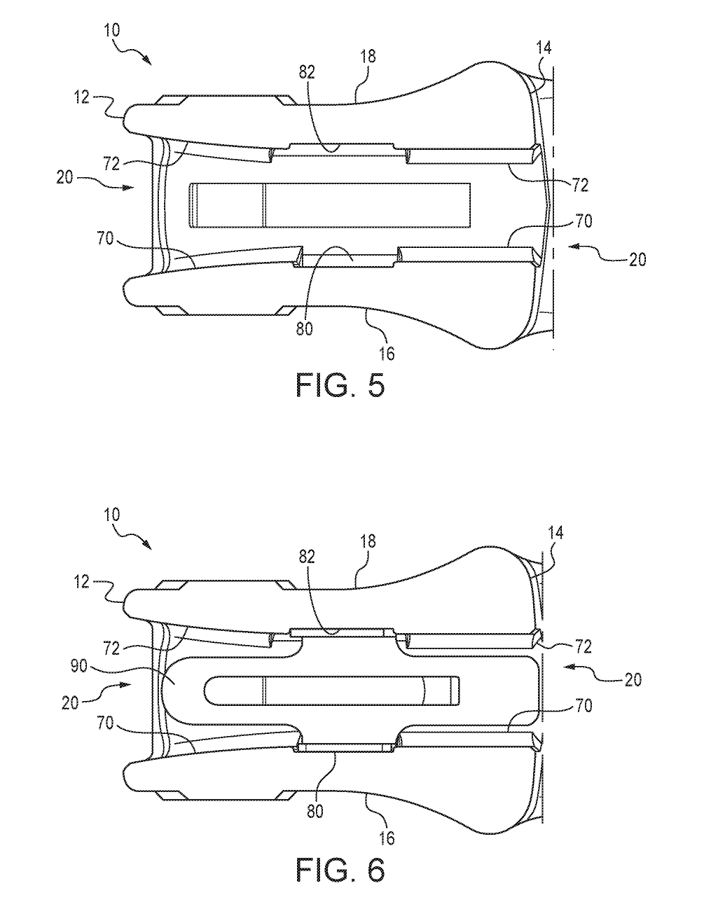

FIG. 5 further illustrates the housing 10 in accordance with the present subject matter without the upper jaw 40 and shank 42 disposed in the channel 20. In this version, one or more recessed “pocket” regions 80 and 82 are provided in walls of the channel 20. In the particular version shown in FIG. 5, a first pocket region 80 is provided along the interior wall 70 at a midpoint of the channel 20 between faces 12 and 14. A second pocket region 82 is provided along the interior wall 72 at a midpoint of the channel 20 between faces 12 and 14. The one or more pocket region(s) can be used to retain a shim, as follows.

Conventional wrenches are known which include a shim or similar component within a housing of the wrench. Such shims or similar components typically function as a spring or biasing member to urge the shank of the upper jaw toward the center of the channel.

In accordance with the present subject matter, a new shim is provided and positioned within a housing to further distribute lateral loading along increased areas of the wrench components in order to reduce the potential for damage from side loading. FIG. 6 illustrates an embodiment of a shim 90 in accordance with the present subject matter. The shim 90 is disposed in the previously described housing 10. In certain versions, the shim 90 is configured to reside within one or more pocket regions in the channel 20 such as pocket regions 80 and 82. It will be understood however, that the present subject matter includes shims that are not configured for placement in one or more pocket regions.

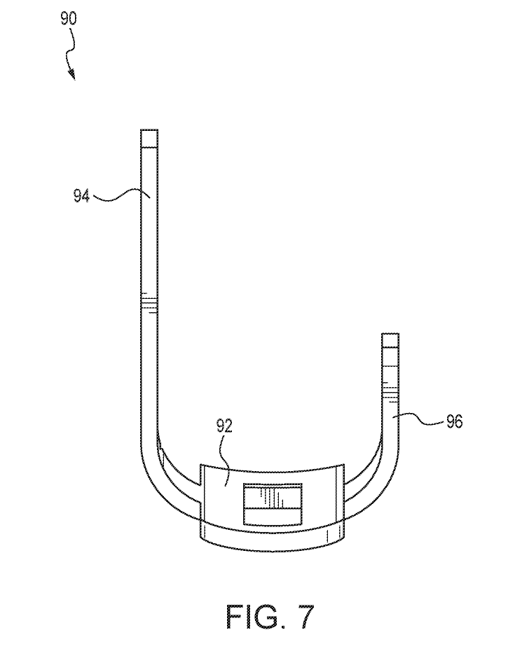

FIG. 7 further illustrates the shim 90 in accordance with the present subject matter. The shim 90 includes a central member 92, a first leg 94 extending outward from the central member 92, and a second leg 96 extending outward from the central member 92. In certain versions, the legs 94 and 96 extend parallel to each other and are spaced apart from one another. In the particular version depicted in FIG. 7, the first leg 94 is longer than the second leg 96. However, it will be appreciated that the present subject matter includes a wide array of variant configurations for the shims. The present subject matter also includes shim assemblies which include two or more components that when disposed in a channel as described herein, function as a shim urging the shank of an upper jaw toward the center of the channel.

Referring to FIGS. 6 and 7, the shim 90 is positioned in the channel 20 relative to a shank 42 of an upper jaw 40 (not shown in FIG. 6) disposed in the channel 20 such that a portion of the shim 90 such as the first leg 94 is disposed between the shank 42 and an interior wall such as wall 70, another portion of the shim 90 such as the second leg 96 is disposed between the shank 42 and an interior wall such as wall 72, and yet another portion of the shim 90 such as the central member 92 is disposed between the shank 42 and another interior wall of the channel. Thus, the shim is positioned at least partially around the shank so as to be positioned between at least three of the interior walls and the shank.

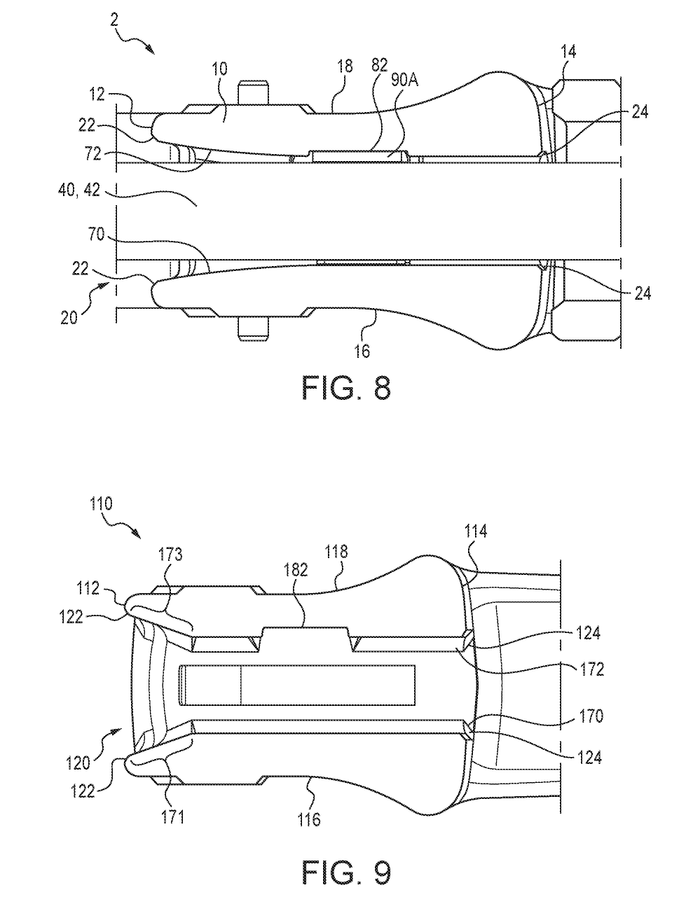

The present subject matter includes the use of conventional shims in a wrench housing that utilizes one or more channel features as described herein. For example, FIG. 8 illustrates a wrench 2 having a housing 10 and upper jaw 40 with a shank 42 disposed in a channel 20. The channel is defined at least in part by interior walls 70 and 72. A single pocket region 82 is provided along the interior wall 72. A conventional shim 90A is at least partially positioned in the single pocket region 82.

The present subject matter includes housings having a variety of different geometries and configurations of the channel. FIG. 9 illustrates another embodiment of a wrench housing 110 in accordance with the present subject matter. For convenience, components are similarly numbered as corresponding components of the previously described embodiment best shown in FIG. 5. FIG. 9 illustrates the housing 110 as defining first and second faces 112 and 114 and a channel 120 extending therebetween. In this embodiment, each of the interior walls 170 and 172 includes a diverging wall portion 171 and 173, respectively. In many embodiments, the diverging wall portions 171 and 173 constitute at least 10%, in certain embodiments at least 25%, and in particular embodiments at least 50% of the respective interior wall. Thus for example, the length of the diverging wall portion 171 constitutes at least 10%, in certain embodiments at least 25%, and in particular embodiments at least 50% of the total length of the interior wall 170. Although FIG. 9 illustrates a single pocket region 182, it will be understood that the present subject matter includes two of more pocket regions provided along interior walls of the channel 120.

In many embodiments of the present subject matter, the channel in the housing extends between openings on the first and second faces of the housing which differ in size. For example, referring to FIG. 8 for example, the housing 10 is provided with a channel 20 extending between a first opening 22 on the first face 12 and a second opening 24 on the second face 14 of the housing 10. Similarly, the housing 110 shown in FIG. 9 is provided with a channel 120 extending between a first opening 122 on the first face 112 and a second opening 124 on the second face 114. In accordance with an aspect of the present subject matter, the area of the first opening 22, 122 is greater than the area of the second opening 24, 124. In particular embodiments, the area of the first opening 22, 122 is greater than the area of the second opening 24, 124 by a specific amount such as 110%, 120%, 130%, 140%, or 150% or more. It will be understood that in this aspect of the present subject matter, the configuration or geometry of the channel extending between the first and second openings can be in a variety of different forms besides the embodiments described herein.

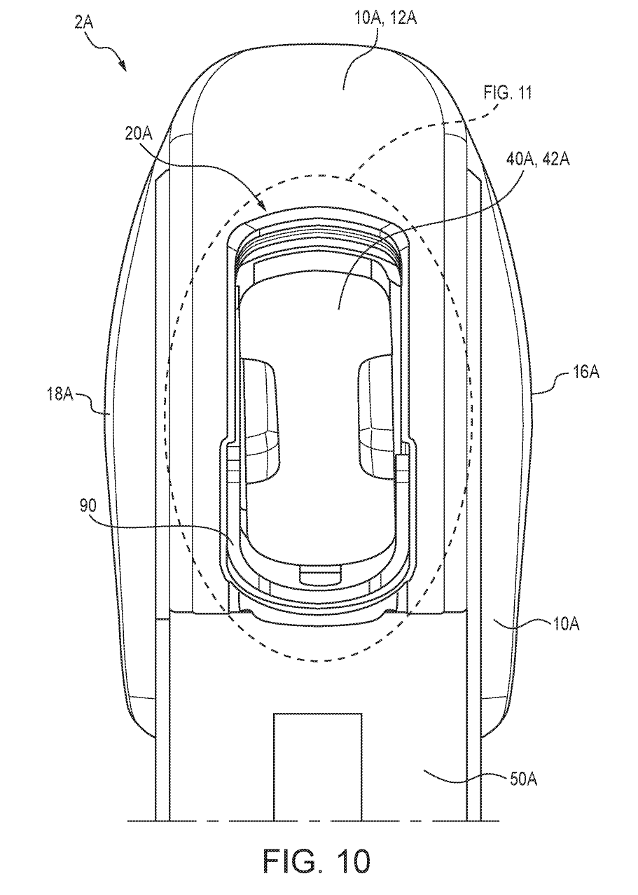

The present subject matter includes the use of a conventional housing with a shim of the present subject matter. FIG. 10 is an end view of a conventional wrench 2A and housing 10A with a shim 90 of the present subject matter. FIG. 10 illustrates a housing 10A and a first face 12A of the housing 10A, with a channel 20A extending through the housing 10A. The housing 10A defines first and second lateral sides 16A and 18A, respectively. The housing 10A is affixed or otherwise integrally formed with a lower jaw 50A. A shank 42A of an upper jaw 40A is disposed in the channel 20A. The previously described shim 90 is also disposed in the channel 20A and is positioned at least partially around the shank 42A.

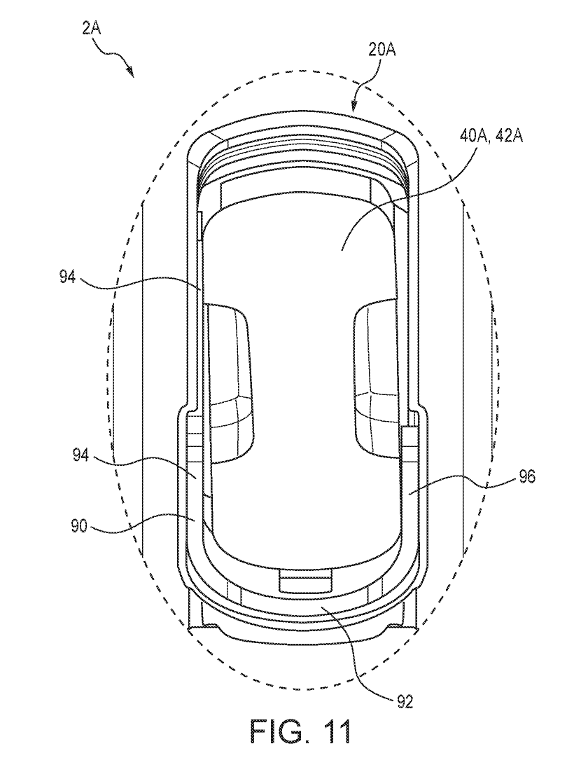

FIG. 11 is a detailed end view showing the shim 90 and its position in the channel 20A and relative to the shank 42A of the upper jaw 40A. The first leg 94 of the shim 90 is positioned between the shank 42A and an interior wall forming the channel 20A. The second leg 96 of the shim 90 is positioned between the shank 42A and another interior wall of the channel 20A. And, the central member 92 is positioned between the shank 42A and another interior wall of the channel 20A.

The present subject matter also provides methods for reducing potential for failure of a wrench due to excessive lateral loading of the wrench, and thus increase capacity of the wrench to lateral loading. The methods involve one or both of (i) provision of a channel extending through the wrench housing in which the channel exhibits certain geometrical features such as those described herein; and/or (ii) provision of a particular shim component in the channel as described herein. Utilization of one or both of these methods has been found to significantly increase capacity of the wrench to accommodate side or lateral loading without damage occurring to the wrench and particularly the wrench housing.

Many other benefits will no doubt become apparent from future application and development of this technology.

All patents, applications, standards, and articles noted herein are hereby incorporated by reference in their entirety.

The present subject matter includes all operable combinations of features and aspects described herein. Thus, for example if one feature is described in association with an embodiment and another feature is described in association with another embodiment, it will be understood that the present subject matter includes embodiments having a combination of these features.

As described hereinabove, the present subject matter solves many problems associated with previous strategies, systems and/or devices. However, it will be appreciated that various changes in the details, materials and arrangements of components, which have been herein described and illustrated in order to explain the nature of the present subject matter, may be made by those skilled in the art without departing from the principle and scope of the claimed subject matter, as expressed in the appended claims.

What is claimed is:

1. A wrench comprising:
a handle having a distal end and a proximate end;
a movable upper jaw having a shank, the shank including a threaded region;
a housing integrally formed with the proximate end of the handle, the housing including a lower jaw portion and a channel sized to receive the shank of the movable upper jaw, the shank of the upper jaw disposed in the channel;
a rotatable member threadedly engaged with the threaded region of the shank of the upper jaw, the member rotatably secured to at least one of the handle and the housing, wherein upon rotation of the member, the distance between the lower jaw and the upper jaw is selectively adjusted;
wherein the channel extends between a first opening on a first face of the housing and a second opening on a second face of the housing, the first face directed toward the upper jaw and the second face directed toward the distal end of the handle, the area of the first opening being greater than the area of the second opening.

2. The wrench of claim 1 wherein the area of the first opening is greater than 110% of the area of the second opening.

3. The wrench of claim 2 wherein the area of the first opening is greater than 120% of the area of the second opening.

4. The wrench of claim 1 wherein the channel is defined by a pair of diverging interior walls extending through at least a portion of the housing.

5. The wrench of claim 1 wherein the channel is defined by a plurality of interior walls extending through the housing between the first face and the second face, and at least one of the plurality of interior walls includes an arcuate portion.

6. The wrench of claim 5 wherein at least two of the plurality of interior walls each includes an arcuate portion.

7. The wrench of claim 6 wherein the two interior walls that include arcuate portions are opposite one another.

8. The wrench of claim 7 wherein the two interior walls that include arcuate portions are each disposed proximate a corresponding side region of the housing.

9. The wrench of claim 1 wherein the channel is defined by a plurality of interior walls extending through the housing, the wrench further comprising:
a shim disposed in the channel and at least a portion of the shim positioned between the shank and at least one interior wall of the plurality of interior walls.

10. The wrench of claim 9 wherein the plurality of interior walls include four interior walls that define the channel and the shim is positioned at least partially around the shank so as to be positioned between at least three of the interior walls and the shank.

11. The wrench of claim 9 wherein at least one of the interior walls defines a recessed pocket region and the shim is at least partially disposed in the pocket region.

12. The wrench of claim 9 wherein the shim includes a central member and a first leg extending outward from the central member and a second leg extending outward from the central member and spaced from the first leg.

13. The wrench of claim 12 wherein the first leg and the second leg are oriented parallel to each other.

14. A wrench comprising:
a handle;
a housing affixed to the handle, the housing defining a first face and a second face oppositely directed from the first face, the housing including a lower jaw proximate the first face, the housing defining a plurality of interior walls defining a channel that extends through the housing between the first face and the second face;
a movable upper jaw having a shank, the shank including a threaded region, at least a portion of the shank disposed in the channel in the housing;
a rotatable member threadedly engaged with the threaded region of the shank of the upper jaw, the member rotatably secured to at least one of the handle and the housing, wherein upon rotation of the member, the distance between the lower jaw and the upper jaw is selectively adjusted;
wherein at least one of the interior walls extending through the housing includes an arcuate region.

15. The wrench of claim 14 wherein the arcuate region is adjacent to the first face of the housing.

16. The wrench of claim 14 wherein the plurality of interior walls includes a first interior wall extending between the first face of the housing and the second face of the housing, and a second interior wall extending between the first face of the housing and the second face of the housing, the first interior wall including a first arcuate region and the second interior wall including a second arcuate region.

17. The wrench of claim 16 wherein both of the first arcuate region and the second arcuate region are disposed adjacent to the first face of the housing.

18. The wrench of claim 17 wherein the first arcuate region and the second arcuate region are disposed on opposing interior walls.

19. The wrench of claim 14 wherein the housing defines a first opening of the channel on the first face of the housing and a second opening of the channel on the second face of the housing, wherein the area of the first opening is greater than the area of the second opening.

20. The wrench of claim 14 wherein the plurality of interior walls include a pair of diverging portions of the interior walls.

21. The wrench of claim 16 wherein the first and the second interior walls are each disposed proximate a corresponding side region of the housing.

22. The wrench of claim 14 further comprising:
a shim disposed in the channel such that at least a portion of the shim is positioned between the shank and an interior wall of the plurality of interior walls.

23. The wrench of claim 22 wherein the plurality of interior walls include four interior walls that define the channel and the shim is positioned at least partially around the shank so as to be positioned between at least three of the interior walls and the shank.

24. The wrench of claim 22 wherein at least one of the interior walls defines a recessed pocket region and the shim is at least partially disposed in the pocket region.

25. The wrench of claim 22 wherein the shim includes a central member and a first leg extending outward from the central member and a second leg extending outward from the central member and spaced from the first leg.

26. The wrench of claim 25 wherein the first leg and the second leg are oriented parallel to each other.

27. A wrench comprising:
a movable upper jaw having a shank, the shank including a threaded region;
a handle having a distal end and a proximate end;
a housing integrally formed with the proximate end of the handle, the housing including a lower jaw portion and a channel sized to receive the shank of the movable upper jaw, the shank of the upper jaw disposed in the channel, the channel defined by a plurality of interior walls extending through the housing;
a rotatable member threadedly engaged with the threaded region of the shank of the upper jaw, the member rotatably secured to at least one of the handle and the housing, wherein upon rotation of the member, the distance between the lower jaw and the upper jaw is selectively adjusted;
a shim disposed in the channel and at least a portion of the shim positioned between the shank and at least three interior walls of the plurality of interior walls defining the channel.

28. The wrench of claim 27 wherein the plurality of interior walls including a pair of diverging interior walls extending through at least a portion of the housing.

29. The wrench of claim 27 wherein at least one of the plurality of interior walls includes an arcuate portion.

30. The wrench of claim 29 wherein at least two of the plurality of interior walls each includes an arcuate portion.

31. The wrench of claim 30 wherein the two interior walls that include arcuate portions are opposite one another.

32. The wrench of claim 31 wherein the two interior walls that include arcuate portions are each disposed proximate a corresponding side region of the housing.

33. The wrench of claim 27 wherein at least one of the interior walls defines a recessed pocket region and the shim is at least partially disposed in the pocket region.

34. The wrench of claim 27 wherein the shim includes a central member and a first leg extending outward from the central member and a second leg extending outward from the central member and spaced from the first leg.

35. The wrench of claim 34 wherein the first leg and the second leg are oriented parallel to each other.

36. The wrench of claim 27 wherein the housing defines a first opening of the channel on a first face of the housing and a second opening of the channel on a second face of the housing, wherein the area of the first opening is greater than the area of the second opening.

37. A method of increasing capacity of a wrench to lateral loading, the method comprising:
providing a wrench including a handle, a housing having a lower jaw and a channel defined by a plurality of interior walls extending through the housing, a movable upper jaw having a threaded shank and the shank disposed in the channel, a rotatable member threadedly engaged with the threaded shank such that upon rotation of the member the distance between the lower jaw and the upper jaw is selectively adjusted;
incorporating at least one feature in the housing of the wrench, the feature selected from:
(i) wherein at least one of the interior walls of the plurality of interior walls that define the channel, includes an arcuate portion;
(ii) wherein the channel extends between a first opening and a second opening defined on the housing, the area of the first opening being greater than the area of the second opening;
(iii) wherein the plurality of interior walls that define the channel include a pair of diverging interior walls;
(iv) a shim disposed in the channel and positioned between at least three of the interior walls of the plurality of interior walls and the shank.

38. The method of claim 37 wherein the feature includes (i).

39. The method of claim 37 wherein the feature includes (ii).

40. The method of claim 37 wherein the feature includes (iii).

41. The method of claim 37 wherein the feature includes (iv).
